(19) United States
(12) Patent Application Publication
(10) Pub. No.: US 2026/0333556 A1
(43) Pub. Date: Oct. 22, 2026

(54) X-RAY SYSTEM

(71) Applicant: KONINKLIJKE PHILIPS N.V., EINDHOVEN (NL)

(72) Inventors: ROLAND PROKSA, NEU WULMSTORF (DE); RUTH WIEBUS, HAMBURG (DE)

(21) Appl. No.: 19/104,380

(22) PCT Filed: Aug. 15, 2023
(86) PCT No.: PCT/EP2023/072425

§ 371 Date: Feb. 18, 2025

(30) Foreign Application Priority Data
Aug. 22, 2022 (EP) 22191434.4

(51) Int. Cl. H05G 1/52; H05G 1/32

(52) U.S. Cl. CPC H05G 1/52; H05G 1/32

(57) ABSTRACT

The present invention relates to an X-ray system (10), comprising: an anode (20); a cathode (30) that comprises an electron emitter filament (40) and focal grid electrodes (50). The system also comprises: a high voltage supply (60); at least one low-medium voltage supply (70); and a controller (80). The controller is configured to control the high voltage supply to apply a first high voltage between the anode and the cathode and to control the high voltage supply to apply a second high voltage between the anode and the cathode. The second high voltage is greater than the first high voltage and the high voltage supply repeatedly switches between applying the first high voltage and applying the second high voltage. The controller is configured to control the low-medium voltage supply to apply at least two voltages to the focal grid electrodes to form a focused electron beam on the anode from electrons emitted from the electron emitter filament. During application of the first high voltage, the controller is configured to control the low-medium voltage supply to form a focused electron beam of a first size on the anode. During application of the second high voltage, the controller is configured to control the low-medium voltage supply to form a focused electron beam of a second size on the anode. The focused electron beam of the second size on the anode is smaller than the focused electron beam of the first size on the anode. During application of the second high voltage between the anode and the cathode, the controller is configured to control the low-medium voltage supply to move the focused electron beam of the second size on the anode periodically such that an effective spot size of the focused electron beam on the anode is increased.

### FIELD OF THE INVENTION

The present invention relates to an X-ray system, a controller, a method of operating an X-ray system, a computer program element for controlling an X-ray system, a computer program element for controlling a controller, and a computer readable medium.

### BACKGROUND OF THE INVENTION

Some X-ray tubes for medical CT imaging use electrostatic electron beam forming in combination with temperature limited emission. The emission current depends on the filament temperature. Although the emission current is controlled via the filament temperature, the tube voltage and the voltage of focal grid electrodes also impact the emission.

In kVp switching (kVp-S) the tube voltage is switched between consecutive acquisition intervals (e.g., 80 kV and 140 kV). The X-ray generation is much more efficient for high voltages. The difference of the X-ray output dose between 80 kV and 140 kV of a tube at the same filament temperature may easily become as large as a factor of 7. For spectral imaging, the flux of the low kV and high kV intervals should be roughly the same to obtain good spectral material separation. The imbalance of the flux between low and high kV in some situations can be partly compensated with longer integration periods for low tube voltages.

Particular problems arise for kVp-S imaging using high gantry rotation speeds in combination where a sufficiently high X-ray dose is required. Fast imaging is then required, with short acquisition times for projections, where the integration period (IP) of the detector must be short. To deliver the requested X-ray dose in the short IP times, the emission current must be high. This means that frequently the X-ray tube is operated at a maximum X-ray tube anode load at the high kVp in the switching cycle. When the tube voltage is switched to the low kVp, the emission current will be decreased (e.g., 20%-30%). In addition, the lower kVp generates much less and lower energy photons. The filament temperature only varies slowly and is generally fixed, and therefore the temperature cannot be used to increase the emission current and hence X-ray emission at the lower tube voltage (e.g., 80 kV). As detailed above, an overall high X-ray dose can be required, and this also means that to achieve this within the short IP time the duration of the lower kVp cannot be increased, and conversely the duration of the higher kVp may need to be increased in order to provide the high X-ray dose. As detailed above this can lead to an X-ray dose of a the low kVp interval being roughly 7 times smaller compared to the X-ray dose of the high kVp interval.

The strong X-ray flux difference of the low and high kVp IPs causes very different signal-to-noise ratios (SNR) in the acquired data. The strong SNR difference is a severe problem for the spectral data processing which works best at about the same SNR levels.

There is a need to resolve this issue.

### SUMMARY OF THE INVENTION

It would be advantageous to have an improved technique for rapid kVp switching that increases the SNR in the acquired low kVp intervals. The present invention is defined by the independent claims, while advantageous embodiments are defined by the dependent claims.

In a first aspect, there is provided an X-ray system, comprising: an anode; a cathode that comprises an electron emitter filament and focal grid electrodes; a high voltage supply; at least one low-medium voltage supply; and a controller. The controller is configured to control the high voltage supply to apply a first high voltage between the anode and the cathode. The controller is configured to control the high voltage supply to apply a second high voltage between the anode and the cathode, and the second high voltage is greater than the first high voltage. The controller is configured to control the high voltage supply to repeatedly switch between applying the first high voltage and applying the second high voltage (kVp switching cycles). The controller is configured to control the at least one low-medium voltage supply to apply at least two voltages to the focal grid electrodes to form a focused electron beam on the anode from electrons emitted from the electron emitter filament. The controller is configured to control the at least one low-medium voltage supply to vary at least one voltage applied to the focal grid electrodes to move the focused electron beam on the anode. During application of the first high voltage between the anode and the cathode, the controller is configured to control the at least one low-medium voltage supply to form a focused electron beam of a first size on the anode. During application of the second high voltage between the anode and the cathode, the controller is configured to control the at least one low-medium voltage supply to form a focused electron beam of a second size on the anode, and the focused electron beam of the second size on the anode is smaller than the focused electron beam of the first size on the anode. During application of the second high voltage between the anode and the cathode the controller is configured to control the at least one low-medium voltage supply to move the focused electron beam of the second size on the anode. During application of the second high voltage between the anode and the cathode the controller is configured to control the at least one low-medium voltage supply to periodically move the focused electron beam of the second size on the anode such that an effective spot size of the focused electron beam on the anode is increased. The electron beam may be moved with a frequency larger than 1 kHz, preferably larger than 10 kHz and more preferably equal to or larger than 20 kHz. By moving the focal spot rapidly compared to an integration period of an X-ray detector, the effective spot size of the electron beam on the anode may be increased. The effective spot size during application of the second high voltage may be the same or similar as the spot size of the focused electron beam during application of the first high voltage.

In this way, the temperature of the filament can be increased for a standard X-ray tube and the focal grid electrodes adjusted such that for a first cathode to anode high voltage of for example 80 kV an electron spot size on the anode of for example 1 mm can be maintained. However, for this filament temperature operation of the cathode to give a 1 mm electron spot size on the anode at the second cathode to anode high voltage of for example 140 kV would lead to an emission current at this cathode/anode voltage that leads to a system power above the maximum achievable-normally the system with a standard cathode operates with a maximum power at 140 kV. Therefore, the focal grid electrodes operate at 140 kV to give a smaller spot size than 1 mm (that at 80 kV), for example 0.8 mm, which leads to a decrease in emission current that would have resulted for a 1 mm spot size, but where the associated power can be what the system can provide. Indeed, the power can be at a maximum. However, with a smaller electron spot size the spatial resolution of the system at 140 kV (with a 0.8 mm spot size) would be greater than that at 80 kV (with a 1 mm spot size), where different spatial resolutions can lead to image quality problems. Therefore, the smaller spot size at 140 kV is moved at a high frequency with respect to an integration period of the X-ray detector, and this movement increases the effective focused electron spot size. The movement can be controlled such that the spatial resolution at 140 kV is the same as that at 80 kV, for example by moving the focused electron beam at 140 kV such that its effective spot size (over the integration period of the X-ray detector) is that same as that at 80 kV. Thus, the resultant X-ray produced per unit time at 80 kV can be increased with respect to what was achieved previously for the standard X-ray tube, because of the increased electron filament temperature, and operation within the system power limit at high voltages, with no spatial resolution issues. Standard X-ray tubes have two focal grid electrodes. The mean value of the low-medium voltages controls the focal spot size, and the difference of these voltages will impact the focal spot position.

In this manner, as the X-ray per unit time at 80 kV can be increased the X-ray flux at 80 kV can be increased relative to that at 140 kV with respect to what was achieved previously and the resultant signal to noise of spectral material decompositions increased. It is noted that throughout this application, the low voltage is exemplified as 80 kV and the high voltage as 140 kV, since these may be typical voltages suitable for spectral imaging with kVp switching. However, the scope of the invention is not limited to these exact voltages, and the skilled person may appreciate that also other high and low voltages may be chosen to get sufficient spectral separation during a dual energy X-ray imaging cycle. E.g. but not limited to a low voltage chosen in the range of 60-100 kV and a high voltage chosen in the range of 120-160 kV.

A fixed X-ray dose can be maintained, with respect to what was previously achieved, but as the X-rays produced per unit time at 80 kV has been increased, for a set “low” cathode to anode high voltage of 80 kV, as a greater flux of X-rays is produced over a set time period, a time period of the “high” cathode to anode high voltage of 140 kV can be decreased, leading to a reduced overall X-ray dose period providing for faster imaging due to a shorter acquisition time for projections (IP times).

In an example, during application of the second high voltage between the anode and the cathode the controller is configured to control the at least one low-medium voltage supply to periodically move the focused electron beam of the second size on the anode with a sinusoidal modulation.

In an example, during application of the second high voltage between the anode and the cathode the controller is configured to control the at least one low-medium voltage supply to periodically move the focused electron beam of the second size on the anode with a square wave modulation.

In an example, during application of the first high voltage between the anode and the cathode the controller is configured to control the at least one low-medium voltage supply to operate the focal grid electrodes in a first mode of operation. During application of the second high voltage between the anode and the cathode the controller is configured to control the at least one low-medium voltage supply to operate the focal grid electrodes in a second mode of operation. The controller is configured to control the high voltage power supply to vary the voltage applied between the anode and the cathode from the first high voltage to the second high voltage, and when the voltage is at a set voltage between the first high voltage and the second high voltage the controller is configured to switch the operation of the focal grid electrodes from the first mode of operation to the second mode of operation. The set voltage is an intermediate voltage between the first high voltage and the second high voltage. The set voltage may preferably be in a range of the first high voltage plus 10% to 90% of the difference between the second high voltage and the first high voltage, more preferably in a range of the first high voltage plus 20% to 80% of the difference between the second high voltage and the first high voltage. As an example, when the first high voltage is 80 kV and the second high voltage is 140 kV, the set voltage may be at 100 kV. The set voltage may be chosen to optimize system performance. The set voltage may be the point when a detector integration period for “low” energy X-rays is succeeded by a detector integration period for “high” energy X-rays during spectral imaging.

In an example, the controller is configured to control an amplitude difference of the sinusoidal modulation or control an amplitude difference of the square wave modulation during variation of the voltage applied between the anode and the cathode from the set voltage to the second high voltage.

In an example, the amplitude difference of the sinusoidal modulation or the amplitude difference of the square wave modulation varies in proportion to a magnitude of the voltage applied between the anode and the cathode.

In an example, during application of the set voltage between the anode and the cathode the product of emission current and the set voltage is at a maximum power level.

To put this another way, the controller holds the cathode to anode voltage at a “low” voltage of for example 80 kV for a time period and then ramps the cathode to anode voltage to a “high” voltage of for example 140 kV over a time period, and then holds the cathode to anode voltage at 140 kV for a time period, and this forms a cycle over which dual energy X-ray are produced providing for spectral imaging. The controller then goes through the reverse operation returning back to 80 kV to produce a second cycle over which dual energy X-ray are produced providing for spectral imaging. At 80 kV the controller controls the focal grid electrodes of the cathode, that are used to focus and move the electron spot on the anode, to provide a first “stationary” spot at a higher emitter temperature than normal. As the thermal spread of electrons is greater than that previously, the focal grid electrodes of the cathode are operating with greater focusing concentration that previously in order to maintain a same focal spot size as that achieved previously-for example 1 mm. But now at 80 kV, the X-rays produced per unit time from the anode are increased over that previously achieved. As the controller rapidly increases the cathode to anode voltage from 80 kV to 140 kV, the focal grid electrodes initially remain with the same configuration as that at 80 kV for simplicity. At an intermediate cathode to anode voltage, for example 100 kV, the controller switches to a second focal grid electrode configuration that will form a focal spot smaller than 1 mm on the anode, for example 0.8 mm. The electron emitter remains at the same temperature, and at the switch point of 100 kV the spot size formed drops below 0.8 mm and the emission current drops. As the cathode to anode voltage increases from 100 kV to 140 kV, the electron focal spot size increases to 0.8 mm and emission current increases. The controller however maintains this 0.8 mm electron spot size, with this emission current, but varies appropriate focal grid electrode voltage difference about an average value to move the focal spot to generate an effective focal spot size that is larger than 0.8 mm, for example 1 mm.

During kVp switching, the cycle times of a kVp switching cycle as described above may be on the order of tenths to hundreds of microseconds, possibly up to a few milliseconds. Hence, transitions of tube voltage and emission current may be very rapid. Transition times between energy levels, i.e. between the plateaus at “high” and “low” (i.e. from high to low or from low to high) voltage may be shorter than 300 μs, such as preferably between 30 μs and 200 μs, or even shorter. (See e.g. the top charts in FIGS. 6-8.)

The electron emitter temperature, the focal grid electrode setting at 80 kV to 100 kV, and the focal grid setting at 100 kV to 140 kV with electron beam movement can be selected such that a maximum system power (emission current x cathode to anode voltage) is a maximum at 140 kV and a maximum at the switch voltage of 100 kV (it will be below the maximum in the 80-99 kV region-up to the switch point), which provides for an optimum system configuration.

In an example, during application of the second high voltage between the anode and the cathode, the product of emission current and the second voltage is at the maximum power level.

In an example, the system comprises an X-ray detector. During application of the second high voltage between the anode and the cathode the controller is configured to control the at least one low-medium voltage supply to move the focused electron beam of the second size on the anode with a frequency greater than a frequency of a detection integration period of the detector.

In an example, during application of the second high voltage between the anode and the cathode the controller is configured to control the at least one low-medium voltage supply to move the focused electron beam of the second size on the anode such that an effective size of the focused electron beam on the anode is equivalent to the focused electron beam of the first size.

In a second aspect, there is provided a controller. The controller is suited to be included in an X-ray system, such as the X-ray system described above. The controller is configured to control at least one low-medium voltage supply to apply at least two voltages to focal grid electrodes of a cathode of an X-ray tube to form a focused electron beam of a first size on an anode of the X-ray tube, where the focused electron beam of the first size is formed from electrons emitted from an electron emitter filament of the cathode when a high voltage supply applies a first high voltage between the anode and the cathode. The controller is configured to control the at least one low-medium voltage supply to apply at least two voltages to the focal grid electrodes of the cathode to form a focused electron beam of a second size on the anode, where the focused electron beam of the second size is formed from electrons emitted from the electron emitter filament when the high voltage supply applies a second high voltage between the anode and the cathode. The focused electron beam of the second size on the anode is smaller than the focused electron beam of the first size on the anode, and the second high voltage is greater than the first high voltage. The high voltage supply repeatedly switches between applying the first high voltage and applying the second high voltage. The controller is configured to control the at least one low-medium voltage supply to vary at least one voltage applied to the focal grid electrodes of the cathode to move the focused electron beam of the second size on the anode periodically such that an effective spot size of the focused electron beam on the anode is increased.

Thus, a standard controller of an existing X-ray system with a standard X-ray tube, which controller controls the X-ray tube to focus the electron beam, can be replaced with the new controller, and immediately the system performance can be increased because the electron emitter can be operated at a higher temperature, and the low energy X-rays emitted per unit time increased in proportion to the high energy X-rays emitted per unit time for the standard controller, whilst maintaining the system within its power capability. Signal to noise can be improved, and with no loss of spatial resolution, leading to improved material decomposition capabilities.

The new controller need not be in control of the high voltage supply, and may only control the focal grid electrodes of the cathode. The new controller may be provided with information regarding how the high voltage supply is operating. The new controller may control the high voltage supply. Just like the existing controller, the controller of the present invention can be provided with information regarding the integration period of an associated X-ray detector, and may be in control of such a detector itself.

In an example, the controller is configured to control the high voltage supply to apply the first high voltage between the anode and the cathode, and the controller is configured to control the high voltage supply to apply the second high voltage between the anode and the cathode.

In a third aspect, there is provided a method of operating an X-ray system, the method comprising:
controlling by a controller at least one low-medium voltage supply to form a focused electron beam of a first size on an anode during application of a first high voltage between the anode and a cathode applied by a high voltage supply, wherein the cathode comprises an electron emitter filament and focal grid electrodes, and wherein the at least one low-medium voltage supply applies at least two voltages to the focal grid electrodes to form the focused electron beam of the first size on an anode;
controlling by the controller the at least one low-medium voltage supply to form a focused electron beam of a second size on the anode during application of a second high voltage between the anode and the cathode applied by the high voltage supply, wherein the at least one low-medium voltage supply applies at least two voltages to the focal grid electrodes to form the focused electron beam of the second size on an anode, wherein the focused electron beam of the second size on the anode is smaller than the focused electron beam of the first size on the anode, wherein the second high voltage is greater than the first high voltage and the high voltage supply repeatedly switches between applying the first high voltage and applying the second high voltage; and
controlling by the controller the at least one low-medium voltage supply to move the focused electron beam of the second size on the anode, and wherein the at least one low-medium voltage supply varies at least one voltage applied to the focal grid electrodes to move the focused electron beam of the second size on the anode periodically such that an effective spot size of the focused electron beam on the anode is increased.

In an aspect, there is provided a computer program element for controlling a system according to the first aspect which when executed by a processor is configured to carry out the method of the third aspect.

In an aspect, there is provided a computer program element for controlling a controller according to the second aspect which when executed by a processor is configured to carry out the method of the third aspect.

Thus, according to aspects, there is provided computer program elements controlling one or more of the systems/controllers as previously described which, if the computer program element is executed by a processor, is adapted to perform the method as previously described.

According to another aspect, there is provided computer readable media having stored the computer elements as previously described.

The computer program element can for example be a software program, but can also be a FPGA, a PLD or any other appropriate digital device.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic representation of an example of an X-ray system;

FIG. 2 shows an example of a method of operating an X-ray system;

FIG. 3 shows a conventional cathode of an X-ray tube, shown at the left in 3D, and at the right in cross-section;

FIG. 4 shows typical behavior of a standard X-Ray tube controlled conventionally;

FIG. 5 shows the behavior of the standard X-Ray tube of FIG. 4 that is controlled in a new manner;

FIG. 6 shows the cathode to anode voltage of the standard X-Ray tube of FIG. 4 along with an example of new control the focal grid electrodes of the cathode;

FIG. 7 shows the cathode to anode voltage of the standard X-Ray tube of FIG. 4 along with an example of new control the focal grid electrodes of the cathode;

FIG. 8 shows the cathode to anode voltage of the standard X-Ray tube of FIG. 4 along with an example of new control the focal grid electrodes of the cathode; and

FIG. 9 shows the spectral performance in terms of signal-to-noise ratio (SNR) in spectral images obtained at a given patient X-Ray radiation intensity.

### DETAILED DESCRIPTION OF EMBODIMENTS

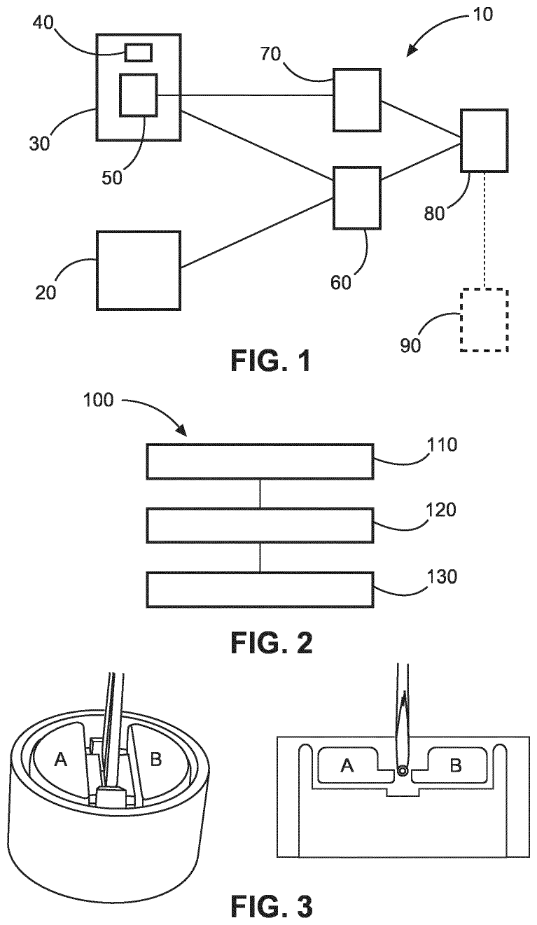

FIG. 1 relates to an X-ray system with a controller 80, where the controller can replace a controller of an existing system. The X-ray system 10 comprises an anode 20, a cathode 30, and the cathode 30 comprises an electron emitter filament 40 and focal grid electrodes 50. There can for example be two focal grid electrodes, one on either side of the electron emitter filament, but there can be three, or four focal grid electrodes. The system 10 also comprises a high voltage supply 60, at least one low-medium voltage supply 70, and the controller 80. The controller is configured to control the high voltage supply to apply a first high voltage between the anode and the cathode. The controller is configured to control the high voltage supply to apply a second high voltage between the anode and the cathode, and the second high voltage is greater than the first high voltage. The controller is configured to control the at least one low-medium voltage supply to apply at least two voltages to the focal grid electrodes to form a focused electron beam on the anode from electrons emitted from the electron emitter filament. The controller is configured to control the at least one low-medium voltage supply to vary at least one voltage applied to the focal grid electrodes to move the focused electron beam on the anode. During application of the first high voltage between the anode and the cathode the controller is configured to control the at least one low-medium voltage supply to form a focused electron beam of a first size on the anode. During application of the second high voltage between the anode and the cathode the controller is configured to control the at least one low-medium voltage supply to form a focused electron beam of a second size on the anode, and the focused electron beam of the second size on the anode is smaller than the focused electron beam of the first size on the anode. During application of the second high voltage between the anode and the cathode the controller is configured to control the at least one low-medium voltage supply to move the focused electron beam of the second size on the anode.

In an example, the at least one low-medium voltage supply is a single voltage unit that can generate two or more separate voltages, where one voltage can be varied whilst other voltage(s) are held invariant and can vary two voltages at the same time, for example in antiphase one with the other (a sine wave and a cosine wave form for example) such that an average of the two voltages remains invariant. As detailed above, if there are three or four focal grid electrodes, then there can be three or four low-medium voltage supplies, but again a more sophisticated supply can supply the necessary voltages. In other words, the at least one low-medium voltage supply can apply the necessary voltages to focal grid electrodes of existing standard cathodes of standard X-ray tubes, and indeed of more sophisticated cathodes of X-ray tubes with more than two focal grid electrodes.

In an example, the at least one low-medium voltage supply is two or more voltage units that can generate two or more separate voltages, where one voltage can be varied whilst other voltage(s) are held invariant and where two voltages can be varied at the same time, for example in antiphase one with the other (a sine wave and a cosine wave form for example) such that an average of the two voltages remains invariant.

In an example, the controller is configured to control the at least one low-medium voltage supply to vary the at least two voltages applied to the focal grid electrodes to move the focused electron beam on the anode.

Thus, a focal spot size for a filament temperature and cathode to anode high voltage is governed by the average voltage on for example two focal grid electrodes. A variation of the voltage on one electrode leads to a movement of the focal spot sideways, but as the average voltage of the two electrodes has varied there will be a slight change in the focal spot size. Therefore, as the voltage of one electrode is increased the voltage of the other electrode can be lowered, such that the average stays the same. The focal spot will again move, but the focal spot size will effectively stay the same.

This also means that when the controller controls the at least one low-medium voltage supply to apply at least two voltages to the focal grid electrodes to form a focused electron beam on the anode from electrons emitted from the electron emitter filament, this could mean that one focal grid electrode is held at a first voltage and a second focal grid electrode is held at a second voltage, and where the first voltage and second voltage are the same-to provide a focal spot at a central neutral position—or where the first voltage is different to the second voltage, where the focal spot will be offset from this central neutral. This is what is meant by “at least two voltages”.

According to an example, during application of the second high voltage between the anode and the cathode the controller is configured to control the at least one low-medium voltage supply to periodically move the focused electron beam of the second size on the anode.

According to an example, during application of the second high voltage between the anode and the cathode the controller is configured to control the at least one low-medium voltage supply to periodically move the focused electron beam of the second size on the anode with a sinusoidal modulation.

According to an example, during application of the second high voltage between the anode and the cathode the controller is configured to control the at least one low-medium voltage supply to periodically move the focused electron beam of the second size on the anode with a square wave modulation.

According to an example, during application of the first high voltage between the anode and the cathode the controller is configured to control the at least one low-medium voltage supply to operate the focal grid electrodes in a first mode of operation. During application of the second high voltage between the anode and the cathode the controller is configured to control the at least one low-medium voltage supply to operate the focal grid electrodes in a second mode of operation. The controller is configured to control the high voltage power supply to vary the voltage applied between the anode and the cathode from the first high voltage to the second high voltage, and during this variation when the voltage is at a set voltage between the first high voltage and the second high voltage the controller is configured to switch the operation of the focal grid electrodes from the first mode of operation to the second mode of operation.

According to an example, the controller is configured to control an amplitude difference of the sinusoidal modulation during variation of the voltage applied between the anode and the cathode from the set voltage to the second high voltage.

According to an example, the controller is configured to control an amplitude difference of the square wave modulation during variation of the voltage applied between the anode and the cathode from the set voltage to the second high voltage.

According to an example, the amplitude difference of the sinusoidal modulation varies in proportion to a magnitude of the voltage applied between the anode and the cathode.

According to an example, the amplitude difference of the square wave modulation varies in proportion to a magnitude of the voltage applied between the anode and the cathode.

According to an example, during application of the set voltage between the anode and the cathode the product of emission current and the set voltage is at a maximum power level.

To put this another way, the controller holds the cathode to anode voltage at a “low” voltage of for example 80 kV for a time period and then ramps the cathode to anode voltage to a “high” voltage of for example 140 kV over a time period, and then holds the cathode to anode voltage at 140 kV for a time period, and this time period is a cycle over which dual energy X-ray are produced providing for spectral imaging. The controller then goes through the reverse operation returning back to 80 kV to produce a second cycle over which dual energy X-ray are produced providing for spectral imaging. At 80 kV the controller controls the focal grid electrodes of the cathode, that are used to focus and move the electron spot on the anode, to provide a first “stationary” spot at a higher emitter temperature than normal. As the thermal spread of electrons is greater than that previously, the focal grid electrodes of the cathode are operating with greater focusing concentration that previously in order to maintain a same focal spot size as that achieved previously-for example 1 mm. But now at 80 kV the X-rays produced per unit time from the anode are increased over that previously achieved. As the controller rapidly increases the cathode to anode voltage from 80 kV to 140 kV the focal grid electrodes initially remain with the same configuration as that at 80 kV for simplicity. At an intermediate cathode to anode voltage, for example 100 kV, the controller switches to a second focal grid electrode configuration that will form a focal spot smaller than 1 mm on the anode, for example 0.8 mm. The electron emitter remains at the same temperature, and at the switch point of 100 kV the spot size formed drops below 0.8 mm and the emission current drops. As the cathode to anode voltage increases from 100 kV to 140 kV the electron focal spot size increases to 0.8 mm and emission current increases. The controller however maintains this 0.8 mm electron spot size, with this emission current, but varies appropriate focal grid electrode voltage difference about an average value to move the focal spot to generate an effective focal spot size that is larger than 0.8 mm, for example 1 mm.

The electron emitter temperature, the focal grid electrode setting at 80 kV to 100 kV, and the focal grid setting at 100 kV to 140 kV with electron beam movement can be selected such that a maximum system power (emission current x cathode to anode voltage) is a maximum at 140 kV and a maximum at the switch voltage of 100 kV (it will be below the maximum in the 80-99 kV region), which provides for an optimum system configuration.

According to an example, during application of the second high voltage between the anode and the cathode the product of emission current and the second voltage is at the maximum power level.

According to an example, the system comprises an X-ray detector 90. During application of the second high voltage between the anode and the cathode the controller is configured to control the at least one low-medium voltage supply to move the focused electron beam of the second size on the anode with a frequency greater than a frequency of a detection integration period of the detector.

According to an example, during application of the second high voltage between the anode and the cathode the controller is configured to control the at least one low-medium voltage supply to move the focused electron beam of the second size on the anode such that an effective size of the focused electron beam on the anode is equivalent to the focused electron beam of the first size. In an example, a temperature of the electron emitter filament is constant.

As detailed above, FIG. 1 also relates to a controller that can for example replace a controller. Reference is now made to the new controller 80. According to an example the controller is configured to control at least one low-medium voltage supply 70 to apply at least two voltages to focal grid electrodes 50 of a cathode 30 of an X-ray tube to form a focused electron beam of a first size on an anode 20 of the X-ray tube. The focused electron beam of the first size is formed from electrons emitted from an electron emitter filament 40 of the cathode when a high voltage supply 60 applies a first high voltage between the anode and the cathode. The controller is configured to control the at least one low-medium voltage supply to apply at least two voltages to the focal grid electrodes of the cathode to form a focused electron beam of a second size on the anode. The focused electron beam of the second size is formed from electrons emitted from the electron emitter filament when the high voltage supply applies a second high voltage between the anode and the cathode. The focused electron beam of the second size on the anode is smaller than the focused electron of the first size on the anode, and the second high voltage is greater than the first high voltage. The controller is configured to control the at least one low-medium voltage supply to vary at least one voltage applied to the focal grid electrodes of the cathode to move the focused electron beam of the second size on the anode.

Thus, a standard controller of an existing X-ray system with a standard X-ray tube that controls the X-ray tube to focus the electron beam can be replaced with the new controller, and immediately the system performance can be increased because the electron emitter can be operated at a higher temperature and the low energy X-rays emitted per unit time increased in proportion to the high energy X-rays emitted per unit time for the standard controller, whilst maintaining the system within its power capability. Signal to noise can be improved, and with no loss of spatial resolution, leading to improved material decomposition capabilities.

The controller need not be in control of the high voltage supply, but only control the focal grid electrodes of the cathode, but be provided with information regarding how the high voltage supply is operating, but it can control the high voltage supply if necessary. As for the existing controller, the controller can be provided with information regarding the integration period of an associated X-ray detector, and can again if necessary be in control of such a detector itself.

According to an example, the controller is configured to control the high voltage supply 60 to apply the first high voltage between the anode and the cathode, and the controller is configured to control the high voltage supply to apply the second high voltage between the anode and the cathode.

In an example, the controller is configured to control the at least one low-medium voltage supply to periodically move the focused electron beam of the second size on the anode.

In an example, the controller is configured to control the at least one low-medium voltage supply to periodically move the focused electron beam of the second size on the anode with a sinusoidal modulation.

In an example, the controller is configured to control the at least one low-medium voltage supply to periodically move the focused electron beam of the second size on the anode with a square wave modulation.

In an example, during application of the first high voltage between the anode and the cathode the controller is configured to control the at least one low-medium voltage supply to operate the focal grid electrodes in a first mode of operation. During application of the second high voltage between the anode and the cathode the controller is configured to control the at least one low-medium voltage supply to operate the focal grid electrodes in a second mode of operation. The controller is configured to control the high voltage power supply to vary the voltage applied between the anode and the cathode from the first high voltage to the second high voltage, and when the voltage is at a set voltage between the first high voltage and the second high voltage the controller is configured to switch the operation of the focal grid electrodes from the first mode of operation to the second mode of operation.

In an example, the controller is configured to control an amplitude difference of the sinusoidal modulation during variation of the voltage applied between the anode and the cathode from the set voltage to the second high voltage.

In an example, the controller is configured to control an amplitude difference of the square wave modulation during variation of the voltage applied between the anode and the cathode from the set voltage to the second high voltage.

In an example, the amplitude difference of the sinusoidal modulation varies in proportion to a magnitude of the voltage applied between the anode and the cathode.

In an example, the amplitude difference of the square wave modulation varies in proportion to a magnitude of the voltage applied between the anode and the cathode.

In an example, the controller is configured to be communicatively linked to an x-ray detector 90, and the controller is configured to control the at least one low-medium voltage supply to move the focused electron beam of the second size on the anode with a frequency greater than a frequency of a detection integration period of the X-ray detector.

In an example, the controller is configured to control the at least one low-medium voltage supply to move the focused electron beam of the second size on the anode such that an effective size of the focused electron beam on the anode is equivalent to the focused electron beam of the first size.

FIG. 2 shows an example of a method 100 of operating X-ray system in its basic steps. The method comprises:
controlling 110 by a controller at least one low-medium voltage supply to form a focused electron beam of a first size on an anode during application of a first high voltage between the anode and a cathode applied by a high voltage supply, wherein the cathode comprises an electron emitter filament and focal grid electrodes, and wherein the at least one low-medium voltage supply applies at least two voltages to the focal grid electrodes to form the focused electron beam of the first size on an anode;
controlling 120 by the controller the at least one low-medium voltage supply to form a focused electron beam of a second size on the anode during application of a second high voltage between the anode and the cathode applied by the high voltage supply, wherein the at least one low-medium voltage supply applies at least two voltages to the focal grid electrodes to form the focused electron beam of the second size on an anode, wherein the focused electron beam of the second size on the anode is smaller than the focused electron beam of the first size on the anode, and wherein the second high voltage is greater than the first high voltage; and
controlling 130 by the controller the at least one low-medium voltage supply to move the focused electron beam of the second size on the anode, and wherein the at least one low-medium voltage supply varies at least one voltage applied to the focal grid electrodes to move the focused electron beam of the second size on the anode.

In an example, during application of the second high voltage between the anode and the cathode the method comprises controlling by the controller the at least one low-medium voltage supplies to periodically move the focused electron beam of the second size on the anode.

In an example, during application of the second high voltage between the anode and the cathode the method comprises controlling by controller the at least one low-medium voltage supply to periodically move the focused electron beam of the second size on the anode with a sinusoidal modulation.

In an example, during application of the second high voltage between the anode and the cathode the method comprises controlling by the controller the at least one low-medium voltage supply to periodically move the focused electron beam of the second size on the anode with a square wave modulation.

In an example, during application of the first high voltage between the anode and the cathode the method comprises controlling by the controller the at least one low-medium voltage supply to operate the focal grid electrodes in a first mode of operation, and during application of the second high voltage between the anode and the cathode the method comprises controlling by the controller the at least one low-medium voltage supply to operate the focal grid electrodes in a second mode of operation. The method can then comprise controlling by the controller the high voltage power supply to vary the voltage applied between the anode and the cathode from the first high voltage to the second high voltage, and the method can comprise switching by the controller the operation of the focal grid electrodes from the first mode of operation to the second mode of operation when the voltage is at a set voltage between the first high voltage and the second high voltage.

In an example, the method comprises controlling by the controller an amplitude difference of the sinusoidal modulation during variation of the voltage applied between the anode and the cathode from the set voltage to the second high voltage.

In an example, the method comprises controlling by the controller an amplitude difference of the square wave modulation during variation of the voltage applied between the anode and the cathode from the set voltage to the second high voltage.

In an example, the amplitude difference of the sinusoidal modulation varies in proportion to a magnitude of the voltage applied between the anode and the cathode.

In an example, the amplitude difference of the square wave modulation varies in proportion to a magnitude of the voltage applied between the anode and the cathode.

In an example, during application of the set voltage between the anode and the cathode the product of emission current and the set voltage is at a maximum power level.

In an example, during application of the second high voltage between the anode and the cathode the product of emission current and the second voltage is at the maximum power level.

In an example, during application of the second high voltage between the anode and the cathode the method comprises controlling by the controller the at least one low-medium voltage supply to move the focused electron beam of the second size on the anode with a frequency greater than a frequency of a detection integration period of a detector.

In an example, during application of the second high voltage between the anode and the cathode the method comprises controlling by the controller the at least one low-medium voltage supply to move the focused electron beam of the second size on the anode such that an effective size of the focused electron beam on the anode is equivalent to the focused electron beam of the first size.

In an example, a temperature of the electron emitter filament is constant.

The X-ray system with the new controller and the new method of operating an X-ray system are now described in specific detail, where reference is made to FIGS. 3-8.

It was realized that although the electron emission from a conventional cathode is controlled via the filament temperature, the tube voltage and the voltages of the focal grid electrodes voltage also impact the emission. It was realized that the filament temperature could be increased, and the voltages of focal grid electrodes changed in order to provide the same focal spot size at 80 kV, but now with an increased electron emission current and thus X-ray emission per unit time from the anode. In order that power requirements at 140 kV are not exceeded for this increased filament temperature it was realized that voltages of the focal grid electrodes could be changed to provide a reduced spot size, with an emission current at this tube voltage of 140 kV that is equivalent to that provided previously, and where for example the X-ray tube can still operate at maximum power. However, during the 140 kV high kept interval of a detector the voltages of the focal grid electrodes are varied about an average to maintain an instantaneous focal spot size but move the focal spot to provide an increased effective spot size, equivalent to that at 80 kV and the low kVp interval. In this way, the spatial resolution in both the low kVp and high kVp interval can be the same, but the flux in the low kVp interval can be increased leading to an increased signal to noise ratio in material decomposition.

Thus, a method of operation of a standard X-ray tube is provided to improve the performance of kVp switching with high emission currents, by rapidly oscillating the focal spot during part of the kVp switching cycle.

To help explain the new technique, an existing typical cathode design is introduced. FIG. 3 shows a typical cathode design. The filament is embedded in a cup with steering grids (focal grid electrodes) on both sides-A and B. The grid voltages are used to position and size the focal spot (FS).

The common part of the voltages defines the FS size. High voltages will constrict the emitted electron beam and form a small focal spot (and vice versa). A voltage difference between the grids can be used to position the focal spot. The common voltage will also impact the emission by changing the electrical field. The grids A and B can be at different voltages.

From an image reconstruction point of view, the focal spot (FS) size for the low and high kVp IP should be similar. Projections with different FS sizes leads respectively to different spatial resolutions that can generate severe problems in the spectral data processing (material decomposition) and should be avoided.

Within a kVp-switching cycle, the FS size will be impacted by the kVp. The FS will typically be larger for high kVp's. To overcome this problem a conventional X-ray tube controller operates such that the FS size is dynamically be adapted within the kVp cycles to maintain a constant FS size. The conventional controller does via appropriate application of voltages to the focal grid electrodes used to size and position the FS.

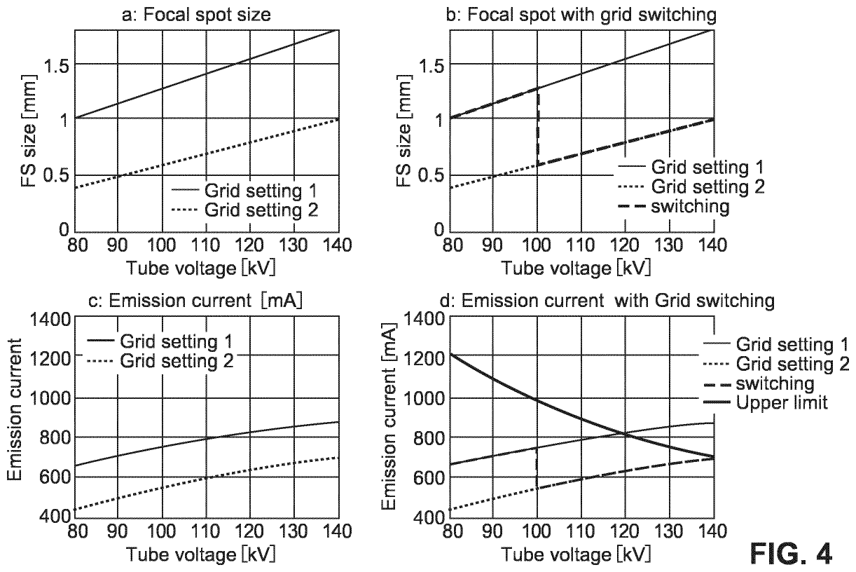

The typical behavior of a standard X-Ray tube with a standard cathode operated with a conventional controller is show in FIG. 4.

To understand the X-ray tube operation, an X-ray detector operates with two integration periods (IPs). In a first IP low energy X-rays are to be acquired and in a second IP high energy X-rays are to be acquired. A high voltage source applies a voltage of 80 kV between the cathode and anode and the conventional controller utilizes a low-medium voltage supply to apply voltage(s) to the focal grid electrodes to form a focal spot of 1 mm. The high voltage can be applied for a set time. The detector is acquiring data in the first IP. The conventional controller, or another controller, then rapidly ramps the cathode to anode voltage upwards, and the voltage(s) applied to the focal grid electrodes stays the same. The focal spot size and emission current then increase as the cathode to anode voltage increases. At a set voltage, here 100 kV, the conventional controller changes the voltages applied to the focal grid electrodes that are commensurate with achieving a focal spot size of 1 mm at 140 kV. In the time duration up to the change at 100 kV the detector operates in the first IP. From the change at 100 kV upwards the detector then operates in the second IP. The focal spot size is immediately reduced upon the change of voltages to the focal grid electrodes as is the emission current. These however increase as the cathode to anode voltage is increased to 140 kV. The system is normally designed such that a maximum power is achieved at 140 kV. The cathode to anode voltage is then held at 140 kV for a time, and then the cathode to anode voltage is rapidly reduced toward 80 kV. At 100 kV the focal grid electrodes switch back to that commensurate with a focal spot size of 1 mm at 80 kV, and the second IP ends and a new first IP begins. This process then repeats.

Continuing with FIG. 4, FIG. 4a shows the FS size for different kVps of 80 kVp and 140 kVp. The two curves are shown for two different settings (1,2) of the focal grid electrodes. The parameters are chosen such that the FS size for 80 kVp and 140 kVp are identical for the two grid settings (1 mm in this example). This ensures the same FS size as requested. FIG. 4b shows the effective FS size if the focal grid electrode setting is switched at 100 kV. FIG. 4c shows the emission current for the two grid settings and the kVp. FIG. 4d shows the emission current if the focal grid electrode setting is switched at 100 kV.

Now, for the operation of the new controller, the filament temperature is increased. During the 80-100 kV region, the controller has changed the focal grid electrode setting (to setting 3) such that a focal spot size of 1 mm at 80 kV is maintained. In the 100-140 kV region, the controller has changed the focal grid electrode setting (to setting 4) such that a smaller focal spot size than 1 mm is achieved and to ensure that the tube power limitation (700 mA at 140 kVp) is not overrun.

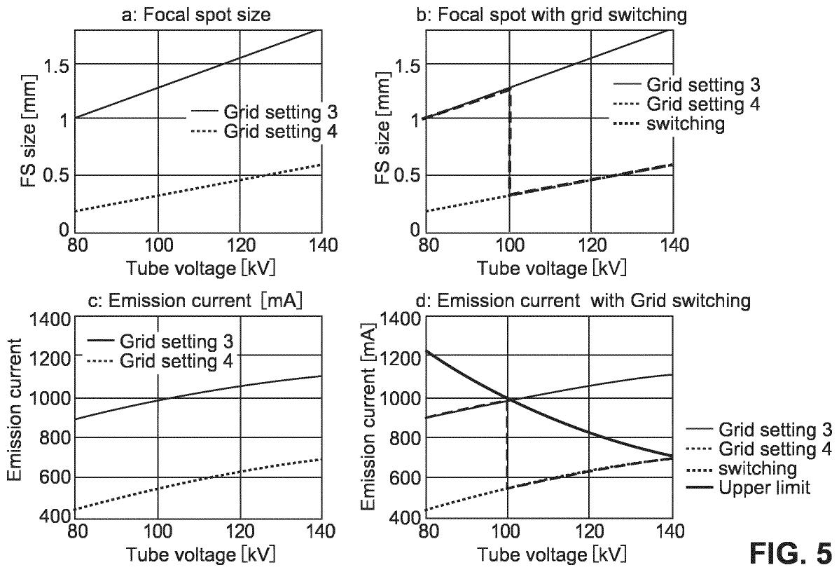

FIG. 5 shows equivalent data to that shown in FIG. 4, but for now operation of the new controller. All but one requirement has been met with these changes. The tube current for the low kVp has been increased by 36% (about 900 mA instead of 660 mA). The maximal power level is not exceeded for 140 kV and nor for the threshold at 100 kV. The focal spot size for the low kVp setting is kept at (1 mm). However, the FS size for 140 kVp is now too small (0.6 mm instead of 1 mm).

Therefore, the new controller operates to effectively create a larger FS (e.g. 1 mm) with a rapid movement of the smaller (e.g. 0.6 mm) FS. The movement is fast compared to the IP time. For example, a movement with a frequency of 20 kHz. will have 20 periods during an IP time of 1 ms. Rapid FS movement is a well-known technique used in the so-called dual-focal-spot switching (DFS) and is not further explained.

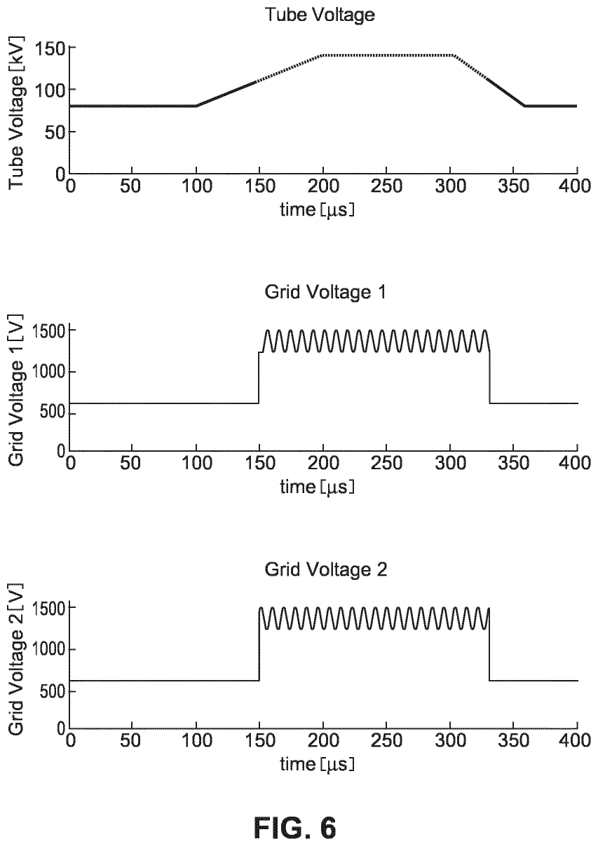

FIG. 6 shows a focal grid voltage waveform with X-ray tube voltage. The upper figure shows a tube voltage waveform for kVp-S, where the cathode to anode voltage is held at 80 kV for a time, rapidly increased to 140 kV and held at this voltage for a time, and then rapidly decreased to 80 kV. As discussed above, the detector operates in a first low energy integration period for tube voltages 80-100 kV and in a second high energy integration period for tube voltages 100-140 kV. In the top figure of Tube voltage against time, the solid and dashed lines represent the lower/upper voltage intervals. The other two plots show the focal grid electrode voltages, which have a constant average level between the two to maintain an instantaneous focal spot size of 0.6 mm, but vary in order to rapidly move the focal spot to create an increased effective focal spot size as “seen” by the detector. Thus, during the low kV intervals, the focal grid electrode voltages are constant and form a constant FS. During the high voltage periods, the focal grid electrode voltages are increased and contain an oscillating voltage difference to move the FS position.

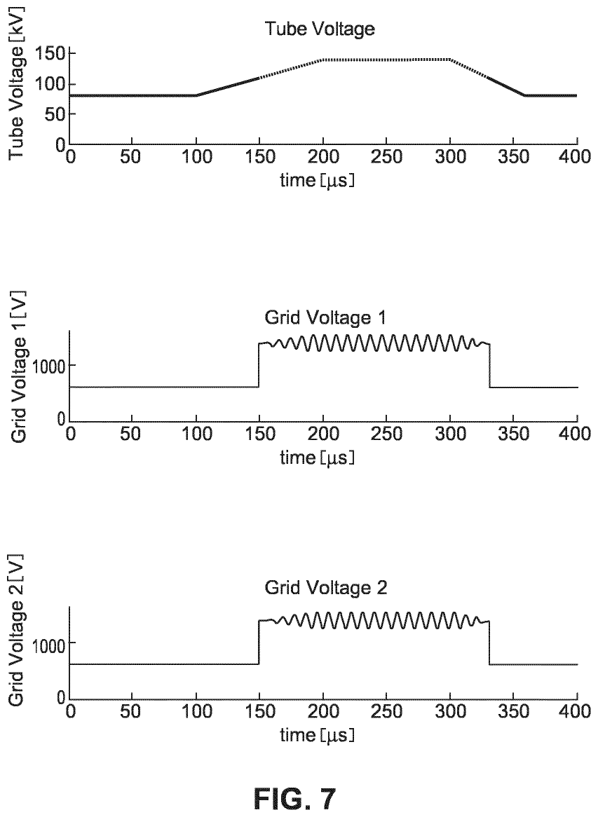

As shown in FIG. 7, the focal grid electrode voltages for the fast movement can be tube voltage adaptive, where the magnitude of voltages applied varies in proportion to the cathode to anode voltage, enabling the movement of the focal spot on the anode to have a same magnitude during the voltage modulation.

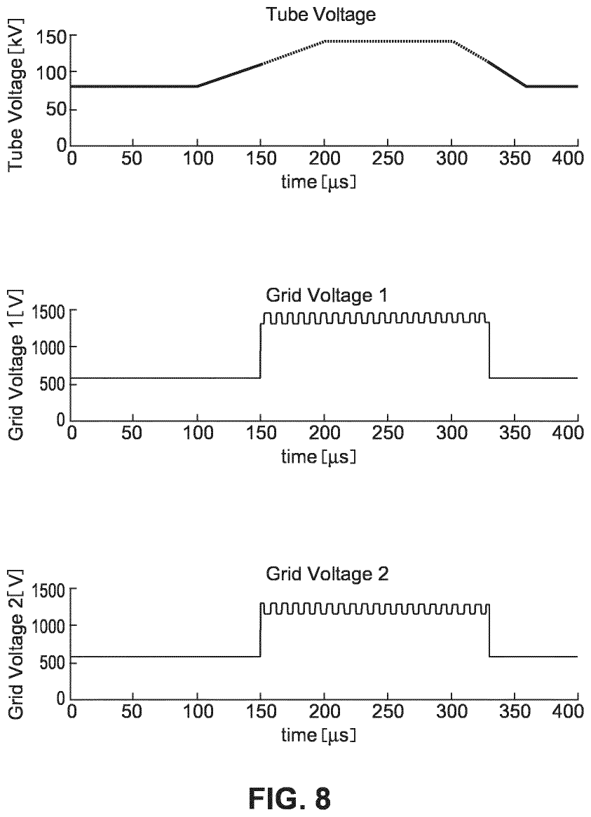

As shown in FIG. 8, the focal grid electrode voltages for the fast movement can be square wave, enabling a technical realization via a switch to be applied that switches between two voltages. This can, in certain situations lead to higher EMI and high frequency problem that do not appear for sinusoidal modulation as shown in FIGS. 6 and 7, but which require more sophisticated than the simple switch for a square wave modulation.

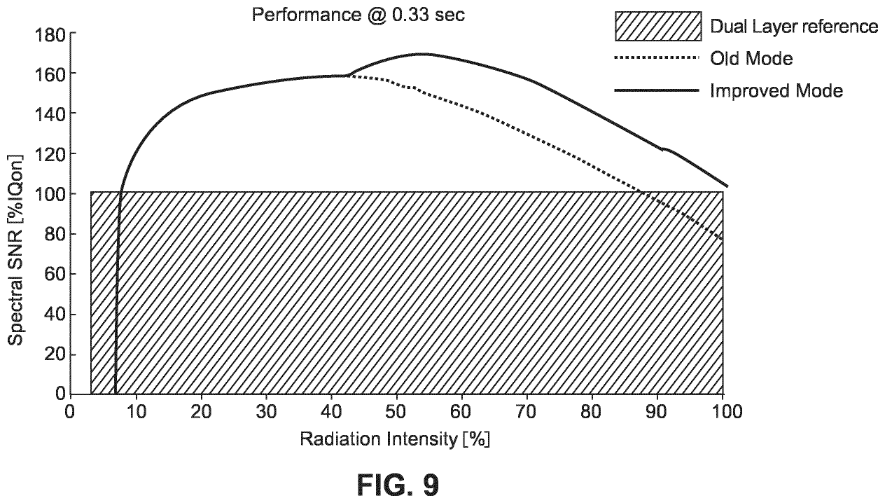

FIG. 9 shows the spectral performance in terms of signal-to-noise ratio (SNR) in spectral images obtained at a given patient X-Ray radiation intensity (in % of the maximal intensity of the X-Ray tube). The spectral SNR is given in % of a Philips Dual Layer CT scanner at the same dose level. The dashed curve shows the performance of the conventional dose. The solid curve shows how the performance can be improved with the proposed operation.

Thus, a new technique of operation of a standard X-ray tube is provided to improve the performance of kVp switching with high emission currents, by rapidly oscillating the focal spot during part of the kVp switching cycle.

Within a kVp switching cycle containing a low kVp interval and a high kVp interval, the focal spot grid electrodes are also switched between low and high voltage settings.

During the low kVp interval, the grid voltages are in the low setting and constant over time.

During the high kVp interval, the grid voltages are switched to rapidly oscillate around a high voltage setting, such that the focal spot rapidly moves within one detector integration period and the effective focal spot size increases.

The result is a switching cycle that enables an increased emission current and an effectively constant focal spot size, thereby achieving an improved signal-to-noise and thus improved spectral imaging performance.

The controller as described above can be used to replace a conventional controller of an X-ray system leading to an immediate improvement in performance.

In another exemplary embodiment, a computer program or computer program element is provided that is characterized by being configured to execute the method steps of any of the methods according to one of the preceding embodiments, on an appropriate apparatus or system.

The computer program element might therefore be stored on a computer unit, which might also be part of an embodiment. This computing unit may be configured to perform or induce performing of the steps of the method described above. Moreover, it may be configured to operate the components of the above-described system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both a computer program that right from the beginning uses the invention and computer program that by means of an update turns an existing program into a program that uses the invention.

Further on, the computer program element might be able to provide all necessary steps to fulfill the procedure of an exemplary embodiment of the method as described above.

According to a further exemplary embodiment of the present invention, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. Measures re-cited in mutually different dependent claims may advantageously be combined. Any reference signs in the claims should not be construed as limiting the scope.

1. An X-ray system, comprising:
an anode;
a cathode comprising an electron emitter filament and focal grid electrodes;
a high voltage supply;
at least one low-medium voltage supply; and
a controller configured to
control the high voltage supply to apply a first high voltage between the anode and the cathode;
control the high voltage supply to apply a second high voltage between the anode and the cathode, and wherein the second high voltage is greater than the first high voltage;
control the high voltage supply to repeatedly switch between applying the first high voltage and applying the second high voltage;
control the at least one low-medium voltage supply to apply at least two voltages to the focal grid electrodes to form a focused electron beam on the anode from electrons emitted from the electron emitter filament; and
control the at least one low-medium voltage supply to vary at least one voltage applied to the focal grid electrodes to move the focused electron beam on the anode;
wherein during application of the first high voltage between the anode and the cathode, the controller is configured to control the at least one low-medium voltage supply to form a focused electron beam of a first size on the anode; wherein during application of the second high voltage between the anode and the cathode, the controller is configured to control the at least one low-medium voltage supply to form a focused electron beam of a second size on the anode, wherein the focused electron beam of the second size on the anode is smaller than the focused electron beam of the first size on the anode; and wherein during application of the second high voltage between the anode and the cathode, the controller is configured to control the at least one low-medium voltage supply to periodically move the focused electron beam of the second size on the anode such that an effective spot size of the focused electron beam on the anode is increased.

2. The system according to claim 1, wherein during application of the second high voltage between the anode and the cathode the controller is configured to control the at least one low-medium voltage supply to periodically move the focused electron beam of the second size on the anode with a sinusoidal modulation.

3. The system according to claim 1, wherein during application of the second high voltage between the anode and the cathode the controller is configured to control the at least one low-medium voltage supply to periodically move the focused electron beam of the second size on the anode with a square wave modulation.

4. The system according to claim 1, wherein during application of the first high voltage between the anode and the cathode, the controller is configured to control the at least one low-medium voltage supply to operate the focal grid electrodes in a first mode of operation, wherein during application of the second high voltage between the anode and the cathode, the controller is configured to control the at least one low-medium voltage supply to operate the focal grid electrodes in a second mode of operation, wherein the controller is configured to control the high voltage power supply to vary the voltage applied between the anode and the cathode from the first high voltage to the second high voltage, and wherein when the voltage is at a set voltage between the first high voltage and the second high voltage, the controller is configured to switch the operation of the focal grid electrodes from the first mode of operation to the second mode of operation.

5. The system according to claim 4, wherein the controller is configured to control an amplitude difference of the sinusoidal modulation or control an amplitude difference of the square wave modulation during variation of the voltage applied between the anode and the cathode from the set voltage to the second high voltage.

6. The system according to claim 5, wherein the amplitude difference of the sinusoidal modulation or the amplitude difference of the square wave modulation varies in proportion to a magnitude of the voltage applied between the anode and the cathode.

7. The system according to claim 4, wherein during application of the set voltage between the anode and the cathode the product of emission current and the set voltage is at a maximum power level.

8. The system according to claim 1, wherein during application of the second high voltage between the anode and the cathode, the product of emission current and the second voltage is at the maximum power level.

9. The system according to claim 1, wherein the system comprises an X-ray detector, and wherein during application of the second high voltage between the anode and the cathode the controller is configured to control the at least one low-medium voltage supply to move the focused electron beam of the second size on the anode with a frequency greater than a frequency of a detection integration period of the detector.

10. The system according to claim 1, wherein during application of the second high voltage between the anode and the cathode the controller is configured to control the at least one low-medium voltage supply to move the focused electron beam of the second size on the anode such that an effective size of the focused electron beam on the anode is equivalent to the focused electron beam of the first size.

11. A computer implemented method of operating an X-ray system, the method comprising:
controlling at least one low-medium voltage supply to form a focused electron beam of a first size on an anode during application of a first high voltage between the anode and a cathode applied by a high voltage supply, wherein the cathode comprises an electron emitter filament and focal grid electrodes, and wherein the at least one low-medium voltage supply applies at least two voltages to the focal grid electrodes to form the focused electron beam of the first size on an anode;
controlling the at least one low-medium voltage supply to form a focused electron beam of a second size on the anode during application of a second high voltage between the anode and the cathode applied by the high voltage supply, wherein the at least one low-medium voltage supply applies at least two voltages to the focal grid electrodes to form the focused electron beam of the second size on an anode, wherein the focused electron beam of the second size on the anode is smaller than the focused electron beam of the first size on the anode, wherein the second high voltage is greater than the first high voltage, and wherein the high voltage supply repeatedly switches between applying the first high voltage and applying the second high voltage; and
controlling the at least one low-medium voltage supply to move the focused electron beam of the second size on the anode, and wherein the at least one low-medium voltage supply varies at least one voltage applied to the focal grid electrodes to move the focused electron beam of the second size on the anode periodically such that an effective spot size of the focused electron beam on the anode is increased.

12. The method according to claim 11, the method further comprising;
controlling the high voltage supply to apply the first high voltage between the anode and the cathode; and
controlling the high voltage supply to apply the second high voltage between the anode and the cathode.

13. (canceled)

14. (canceled)

15. A non-transitory computer readable medium comprising executable instructions which, when executed by at least one processor, cause the at least one processor to perform a method for operating an X-ray system, the method comprising:
controlling at least one low-medium voltage supply to form a focused electron beam of a first size on an anode during application of a first high voltage between the anode and a cathode applied by a high voltage supply, wherein the cathode comprises an electron emitter filament and focal grid electrodes, and wherein the at least one low-medium voltage supply applies at least two voltages to the focal grid electrodes to form the focused electron beam of the first size on an anode;
controlling the at least one low-medium voltage supply to form a focused electron beam of a second size on the anode during application of a second high voltage between the anode and the cathode applied by the high voltage supply, wherein the at least one low-medium voltage supply applies at least two voltages to the focal grid electrodes to form the focused electron beam of the second size on an anode, wherein the focused electron beam of the second size on the anode is smaller than the focused electron beam of the first size on the anode, wherein the second high voltage is greater than the first high voltage, and wherein the high voltage supply repeatedly switches between applying the first high voltage and applying the second high voltage; and
controlling the at least one low-medium voltage supply to move the focused electron beam of the second size on the anode, and wherein the at least one low-medium voltage supply varies at least one voltage applied to the focal grid electrodes to move the focused electron beam of the second size on the anode periodically such that an effective spot size of the focused electron beam on the anode is increased.
